(19) United States
(12) Patent Application Publication
(10) Pub. No.: US 2011/0148194 A1
(43) Pub. Date: Jun. 23, 2011

(54) HIGH VOLTAGE DIRECT CURRENT UNINTERRUPTIBLE POWER SUPPLY SYSTEM WITH MULTIPLE INPUT POWER SOURCES

(75) Inventors: Yuan-Fang Lai, Taoyuan Hsien (TW); Yu-Rong Chen, Taoyuan Hsien (TW)

(73) Assignee: DELTA ELECTRONICS, INC., Taoyuan Hsien (TW)

(21) Appl. No.: 12/851,787

(22) Filed: Aug. 6, 2010

Related U.S. Application Data
(60) Provisional application No. 61/287,476, filed on Dec. 17, 2009.

(51) Int. Cl. H02J 1/10; H02J 9/00

(52) U.S. Cl. 307/23; 307/68; 307/66

(57) ABSTRACT

The invention discloses a high-voltage direct-current uninterruptible power supply system configured to be connected to a plurality of power sources. The uninterruptible power supply system according to the invention includes a plurality of power modules, each of which is connected to a power source for receiving an input power from the power source connected thereto and converting the input power into a direct-current output power, a control module connected to the power modules through communication lines for managing the power modules, and a power distribution unit connected to a DC voltage bus for relaying the direct-current output power to a plurality of electronic devices.

### CROSS-REFERENCE TO RELATED APPLICATION

This application claims the benefit of U.S. Provisional Application No. 61/287,476, filed on Dec. 17, 2009, and entitled “HIGH VOLTAGE DIRECT CURRENT UNINTERRUPTIBLE POWER SUPPLY SYSTEM WITH MULTIPLE INPUT SOURCES OF POWER”, the entirety of which is hereby incorporated by reference.

### FIELD OF THE INVENTION

The present invention relates to an uninterruptible power supply system, and more particularly to a high voltage direct current uninterruptible power supply system with multiple input power sources.

### BACKGROUND OF THE INVENTION

The effects of global warming and climate change are of primary concern both for the environment and human life. Due to the greenhouse effect caused by global warming, the variation of temperature all over the world is getting more and more significant. The environmental concerns and the demands for energy-saving and CO₂ reduction will lead the manufacturer to produce power electronic products, such as switch mode power supply or uninterruptible power supply, with reduced power loss and higher efficiency. Therefore, high voltage direct current uninterruptible power supply (HVDC UPS) system is developed and carried out for achieving the requirements of energy-saving, high efficiency, high reliability, high power quality, and high cost-effectiveness.

Please refer to FIGS. 1A and 1B, which are schematic diagrams respectively showing conventional uninterruptible power supply system and HVDC UPS system applied for data center. A conventional uninterruptible power supply system 1 employs two-stage power conversion circuits including AC to DC converter 11, i.e. rectifier, and DC to AC converter 12, i.e. inverter, for providing required AC power to the loads. In addition, the HVDC UPS system 2 neglects the DC to AC converter (i.e. inverter) and uses single stage AC to DC converter 21 for providing required DC power to the loads directly. Due to the absence of DC to AC converter (i.e. inverter), the power loss resulting in the DC to AC converter will be reduced and therefore the efficiency of the power supply system will be increased. However, both the conventional uninterruptible power supply system 1 and the HVDC UPS system 2 can receive only single AC input power source, such as utility power source, and can not utilize the natural-energy power sources or renewable power sources and manage the power input of the power system effectively. Therefore, it is desired to develop a high voltage direct current uninterruptible power supply system with multiple input power sources to achieve the requirements of energy-saving, cost-saving, high efficiency, and high reliability.

### SUMMARY OF THE INVENTION

An object of the invention is to provide a high-voltage direct-current uninterruptible power supply system configured to receive input electric power from multiple power sources.

According to a preferred embodiment of the invention, a high-voltage direct-current uninterruptible power supply system is provided for incessantly supplying power to electronic devices disposed on the rack. The high-voltage direct-current uninterruptible power supply system includes a plurality of power modules each connected to a power source for receiving an input power from the connected power source and converting the input power into a direct current output power, a control module connected to the power modules through communication lines for monitoring the operating status of the power modules and controlling the power output of the power modules, and a power distribution unit connected to a DC voltage bus for relaying the direct-current output power to a plurality of electronic loads.

According to another preferred embodiment of the invention, a high-voltage direct-current uninterruptible power supply is provided for incessantly supplying power to electronic devices disposed on the rack. The high-voltage direct-current uninterruptible power supply system includes a plurality of power modules, a DC voltage bus and a control module. The power modules comprise at least one primary power module and at least one secondary power module. The primary power module is connected to a natural-energy power generator or renewable-energy power generator for receiving an input power from the connected natural-energy power generator or renewable-energy power generator and converting the input power into a direct-current output power. The secondary power module is connected to a utility AC power source for receiving an input power from the connected utility AC power source and converting the input power into a direct-current output power. The DC voltage bus is connected to plural output terminals of the power modules for receiving the direct-current output power. The control module is connected to the power modules through communication lines for monitoring the operating status of the power modules and controlling the power output of the power modules.

Now the foregoing and other features and advantages of the present invention will be best understood through the following descriptions with reference to the accompanying drawings, wherein:

### BRIEF DESCRIPTION OF THE DRAWINGS

FIGS. 1A and 1B are schematic diagrams respectively showing conventional uninterruptible power supply system and conventional HVDC UPS system applied for data center;

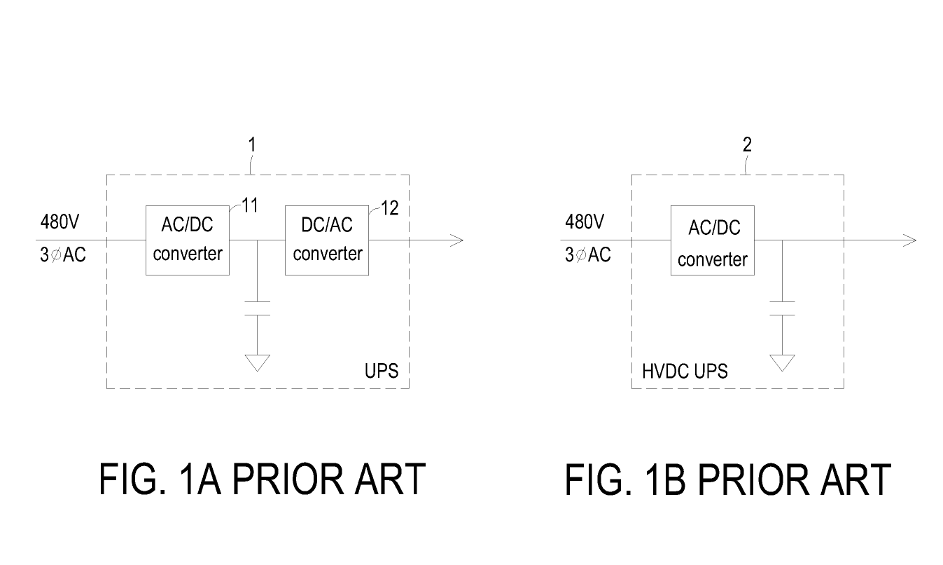

FIG. 2 is a schematic diagram showing a high voltage direct current uninterruptible power supply system with multiple input power sources according to a preferred embodiment of the present invention; and

FIG. 3 is a structural view showing the HVDC UPS system of FIG. 2.

### DESCRIPTION OF THE PREFERRED EMBODIMENT

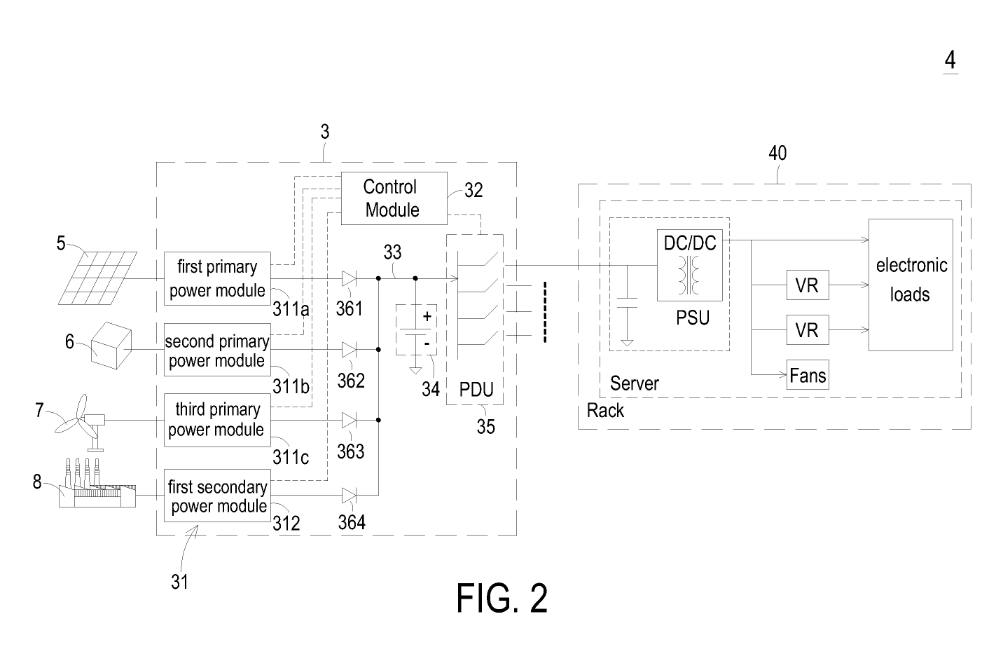

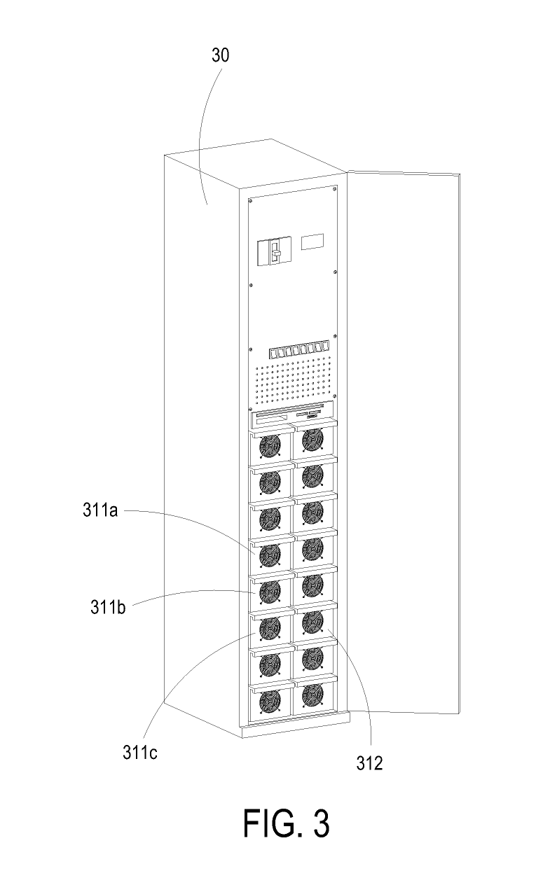

Please refer to FIG. 2, which is a schematic diagram showing a high voltage direct current uninterruptible power supply system with multiple input power sources according to the preferred embodiment of the present invention. As shown in FIG. 2, the HVDC UPS system 3 is applied for a data center 4 including plural racks or servers 40, but it is not limited thereto. The HVDC UPS system 3 includes a cabinet 30 (as shown in FIG. 3), a plurality of power module 31, a control module 32, a DC voltage bus bar 33 and at least one battery module 34. The output terminals of the power modules 31 are connected in parallel and further connected to the bus bar 33. The battery module 34 is coupled to the bus bar 33 for storing and conditioning the energy. The power modules 31 are hot-swappable and capable of bi-directionally communicating with the control module 32 via communication lines respectively. In an embodiment, each output terminal of the power modules 31 is coupled with a corresponding current-direction limiting element, such as diode 361, 362, 363, 364. A power distribution unit 35 (i.e. PDU) is coupled to the bus bar 33 and has a plurality of switching circuits for respectively coupling with a corresponding rack 40. Therefore, the HVDC UPS system 3 can provide and deliver the required energy to power supply units of the data-processing equipments or racks through the power distribution unit 35.

The HVDC UPS system 3 has multiple input power sources 5, 6, 7, 8. In an embodiment, the HVDC UPS system 3 has one or more natural-energy or renewable-energy input power sources 5, 6, 7 and one utility AC input power source 8 (i.e. power plant). The natural-energy or renewable-energy input power sources 5, 6, 7 include DC input power sources and/or AC input power sources, wherein the DC input power sources include for example solar power generator 5 and fuel cell power generator 6, and the AC input power source includes for example wind power generator 7.

The natural-energy or renewable-energy input power sources 5, 6, 7 are served as the main power sources of the HVDC UPS system 3, and the utility AC input power source is served as an auxiliary power source of the HVDC UPS system 3. In an embodiment, the solar power generator 5 (i.e. first DC input power source) is coupled to the input terminal of the first primary power module 311a. The first primary power module 311a includes a DC to DC power converter (not shown) for receiving the DC power from the solar power generator 5 and converting the DC power into high voltage DC (for example 380V) to be outputted to the DC bus bar 33. The fuel cell power generator 6 (i.e. second DC input power source) is coupled to the input terminal of the second primary power module 311b. The second primary power module 311b includes a DC to DC power converter (not shown) for receiving the DC power from the fuel cell power generator 6 and converting the DC power into high voltage DC (for example 380V) to be outputted to the DC bus bar 33. The wind power generator 7 (i.e. first AC input power source) is coupled to the input terminal of the third primary power module 311c. The third primary power module 311c includes an AC to DC power converter (not shown) for receiving the AC power from the wind power generator 7 and converting the AC power into high voltage DC (for example 380V) to the DC bus bar 33.

The utility AC input power source 8 is coupled to the input terminal of the first secondary power module 312. The first secondary power module 312 includes a AC to DC power converter (not shown) for receiving the utility AC power from the power plant and converting the AC power into high voltage DC (for example 380V) to be outputted to the DC bus bar 33.

The power modules 31 are modularized power modules and hot-swappable installed in the receptacles of the cabinet 30 as shown in FIG. 3. The primary power modules 311a, 311b, 311c are employed for coupling with the natural-energy or renewable-energy input power sources 5, 6, 7, and the secondary power module 312 is employed for coupling with the utility AC input power source 8. All the power modules 31 are employed for converting the input power into high voltage DC power (for example 380V) and providing the high voltage DC power through the diodes 361, 362, 363, 364 to the DC bus bar 33. The high voltage DC power on the bus bar 33 can be further delivered to the power distribution unit 35 and the power distribution unit 35 can distribute the required energy to the power supply units of the racks. The battery module 34 is coupled to the DC bus bar 33. In the event of a fault on the multiple input power sources, a battery module 34 can release the stored energy to the DC bus bar 33 to supply the required energy to the loads. Therefore, the battery module 34 can maintain a continuous supply of electric power to the loads, so as to increase the reliability. The power modules 31 can also monitor the input current delivered from the multiple input power sources 5, 6, 7, 8. The control module 32 is employed to communicate with the power modules 31, monitor and control the operating status of the power modules 31 and manage the energy outputs of the power modules 31. The control module 32 is also coupled to the power distribution unit 35 for monitoring the status of the loads so that the control module 32 can control the operating status of the power modules 31 and manage the energy outputs of the power modules 31 according to the status of the loads.

According to the concept of the present invention, the primary power modules 311a, 311b, 311c of the HVDC UPS system 3 can deal with the power conversion of the input power supplied form the natural-energy or renewable-energy input power sources 5, 6, 7 and integrate all the energy into the power supply system, so that the HVDC UPS system 3 of the present invention can effectively manage, control and distribute the energy input among various natural-energy or renewable-energy input power sources 5, 6, 7 and the utility AC input power source 8 under the conditions of different light exposure amount (i.e. at day time or at night time) and climate changes. In a case that the light exposure amount is sufficient at day time, the solar power generator 5 is served as the main power source of the HVDC UPS system 3 and the utility AC input power source 8 is served as the auxiliary power source by the controlling of the control module 32. When the light exposure amount is sufficient at day time, the HVDC UPS system 3 is configured to receive major input energy from the solar power generator 5. If the energy received by the HVDC UPS system 3 is insufficient form the solar power generator 5 (for example 90% of the total required energy), the utility AC input power source 8 can be employed to support the solar power generator 5 to provide the difference of energy (for example 10% of the total required energy) for the HVDC UPS system 3. In an embodiment, when the climate changes and the wind is blowing hard, the HVDC UPS system 3 is configured to receive major input energy from the wind power generator 7. If the energy received by the HVDC UPS system 3 is insufficient from the wind power generator 7 (for example 80% of the total required energy), the utility AC input power source 8 can be employed to support the wind power generator 7 to provide the difference of energy (for example 20% of the total required energy) for the HVDC UPS system 3. Therefore, the high voltage direct current uninterruptible power supply system with multiple input power sources of the present invention can achieve the requirements of energy-saving, cost-saving, high efficiency and reliability.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A high-voltage direct-current uninterruptible supply system configured to be connected to a plurality of power sources, comprising:
a plurality of power modules, each of which is connected to a power source for receiving an input power from the power source connected thereto and converting the input power into a direct-current output power;
a control module connected to the power modules through communication lines for monitoring the operating status of the power modules and controlling the power output of the power modules; and
a power distribution unit connected to a DC voltage bus for relaying the direct-current output power to a plurality of electronic loads.

2. The high-voltage direct-current uninterruptible power supply system according to claim 1 wherein the power sources include natural-energy power generators or renewable-energy power generators.

3. The high-voltage direct-current uninterruptible power supply system according to claim 2 wherein the power sources include a solar power generator, a fuel cell power generator, and a wind power generator.

4. The high-voltage direct-current uninterruptible power supply system according to claim 3 wherein the power sources include a utility AC power source.

5. The high-voltage direct-current uninterruptible power supply system according to claim 1 wherein the power module includes a DC-DC converter or an AC-DC converter for converting the input power into a direct-current output power.

6. The high-voltage direct-current uninterruptible power supply system according to claim 1 wherein the control module is further connected to the power distribution unit for monitoring the operating status of the electronic loads, thereby enabling the control module to monitor the operating status of the power modules and manage the power output of the power modules according to the operating status of the electronic loads.

7. The high-voltage direct-current uninterruptible power supply system according to claim 1 further comprising a battery module connected to the DC voltage bus for storing energy and releasing energy stored therein to the DC voltage bus in the event that the power modules fail to receive input power from the power sources.

8. The high-voltage direct-current uninterruptible power supply system according to claim 1 wherein the electronic loads includes data centers including a plurality of servers.

9. A high-voltage direct-current uninterruptible supply system, comprising:
a plurality of power modules comprising at least one primary power module and at least one secondary power module, wherein the primary power module is connected to a natural-energy power generator or renewable-energy power generator for receiving an input power from the natural-energy power generator or renewable-energy power generator connected thereto and converting the input power into a direct-current output power, and the secondary power module is connected to a utility AC power source for receiving an input power from the utility AC power source connected thereto and converting the input power into a direct-current output power;
a DC voltage bus connected to plural output terminals of the power modules for receiving the direct-current output power; and
a control module connected to the power modules through communication lines for monitoring the operating status of the power modules and controlling the power output of the power modules.

10. The high-voltage direct-current uninterruptible power supply system according to claim 9 wherein the natural-energy power generator or renewable-energy power generator is served as a main power source and the utility AC input power source is served as an auxiliary power source by the controlling of the control module.
